(19) United States
(12) Patent Application Publication
(10) Pub. No.: US 2011/0126600 A1
(43) Pub. Date: Jun. 2, 2011

(54) CYLINDER LOCK WITH CYLINDER HOUSING AND FLAT KEY FOR A CYLINDER LOCK

(76) Inventor: Walter Baumhauer, Wien (AT)

(21) Appl. No.: 13/054,998

(22) PCT Filed: Aug. 10, 2009
(86) PCT No.: PCT/EP09/05786

§ 371 Date: Feb. 10, 2011

(30) Foreign Application Priority Data
Aug. 12, 2008 (AT) A1256/2008

(51) Int. Cl. E05B 19/06; E05B 9/04; E05B 27/02

(52) U.S. Cl. 70/374; 70/449

(57) ABSTRACT

The invention relates to a cylinder lock comprising housing pins (3) and cylinder core pins (4), wherein the cylinder core pins are formed on the end protruding into the key channel (7) as sensing extensions (8) that are narrower than the diameter of the cylinder core pin and are oriented in the longitudinal direction of the key channel, wherein at least two cylinder core pins have sensing extensions that are different from one another, arranged either centrally along the centre longitudinal plane of the key channel or offset at a distance parallel thereto and are intended for sensing milled incisions (17, 18) on the narrow side(s) (15) of the key, wherein approximately parallel core pin bores with resiliently prestressed core pins (6) that can be moved therein are provided on at least one side of the key channel, which pins have sensing lugs (9) protruding into the key channel and ending at a distance from the centre longitudinal plane for sensing milled incisions (16) at the edge(s) of the narrow side(s) of the key, the distance of the sensing lugs from the centre longitudinal plane being greater than the distance of the sensing extensions of the cylinder core pins arranged offset to the left or right of the centre longitudinal plane.

The invention relates to a cylinder lock with a cylinder plug and a casing in which spring-loaded tumbler pins are provided, the lock comprising edge casing pins and edge plug pins for engaging bit cutouts located on the key, the edge plug pins being formed with engagement extensions provided on an inner face and projecting into the key slot, these extensions being narrower than a diameter of the cylinder plug pin and being aligned in a row longitudinally of the key slot, at least two edge plug pins having engagement extensions that are different from one another and positioned either centrally along a central longitudinal plane of the key slot or offset at a spacing roughly parallel thereto on the left and right side faces, these engagement extensions being provided to engage the bit cutouts along the edge(s) of the key.

AT 503 166 discloses a cylinder lock with a flat key that has the above-referenced features. Although this lock does provide for an increase in the number of variations based on the differing entrainment possibilities on the edges of the key, it is always the case that only one position can be engaged per engagement position. Further increasing the possible variations in the bit cutouts or shaped grooves on the key, however, would normally result in making construction of the lock more complex, something that is both disadvantageous for the functional reliability of the lock and that would also result in higher productions costs.

Increasing the number of variations on a flat key is usually possible only by employing a wide variety of cutting machines or using multiple steps to work the blank on different machines, this approach also causing the cost incurred for a single key to rise significantly.

The object of this invention is therefore to create a lock that significantly increases the possible variations for the above-referenced lock, and also to create a lock that has a significantly higher number of possible variations in encoding the key while maintaining the same cost of construction. Another goal, of course, is to provide increased functional reliability and to keep the overall production costs low.

This is achieved by the cylinder lock according to the invention using an approach whereby plug pin bores are provided that are parallel to one another on at least one side of the key slot with spring-loaded side plug pins movable therein, the side plug pins having catch lugs projecting into the key slot and terminating short of the central longitudinal plane, the catch lugs being provided to engage the bit cutouts on the edge(s) of the edge(s) of the key, a spacing of the catch lugs from the central longitudinal plane being greater than a spacing of the engagement extensions of the edge plug pins offset to the left or the right of the central longitudinal plane.

For purposes of engaging the plug pins, these have on their flanks facing away from the key slot at least one release groove to engage a entrainment stud of a locking element, the locking element being also associated with a detent recess of the cylinder casing. As a result, the entrainment stud is able to penetrate the release groove of the plug pin only with the correct key, thereby enabling the locking element to be moved out of the detent recess of the cylinder casing when the cylinder plug is turned.

Another feature of the invention is that one row each of plug pins with catch lugs is provided on at least one side of the key slot, where at least two, preferably five, plug pins with catch lugs are provided in a row along one side of the key slot. The catch lugs enable the edge-side bit cutouts to be engaged on the edge of the key, where a total of ten engagement positions can be engaged simultaneously in a conventional cylinder lock having, for example, five plug pins and five side plug pins, which approach significantly increases the possible variations for the lock.

Another feature of the invention is the fact that at least one cylinder plug pin and one plug pin with catch lug, preferably two plug pins with catch lugs, are provided in the range of a engagement position, with the result that in the range of this position the lock is capable of enabling at least two, preferably three, bit cutouts to be engaged along the edge(s) of the lock. Although a locking cylinder design based on the above-referenced prior art enables the number of variations for the lock to be increased due to the fact that the bit cutouts can have not only different depths but also different positions perpendicular to the central longitudinal plane along the edge of the key, nevertheless, it is still only one position in the range of the engagement position that can be engaged with this type of lock. The locking cylinder according to the invention enables up to three bit cutouts to be engaged in the range of the engagement position along the edge of the key.

According to another feature of the invention, the engagement extensions of the plug pins are in the form of ridges that are able to be disposed at a normal distance parallel to the central longitudinal plane or centrally along the central longitudinal plane. The engagement extensions of the plug pins can furthermore be of identical or differing widths. The plug pins can have side ridges that are disposed in complementary grooves in the cylinder plug so as to prevent the plug pins from turning.

Another feature of the invention is that the key slot has a guide chamfer at its outer slot end, which chamfer is oriented at an angle greater than 0° and less than 90° relative to the vertical, and is configured so as to interact with curved guide surfaces located on the guide tip.

The above-referenced object is furthermore achieved by a flat key for a cylinder lock that in the range of an engagement position has at least two, preferably three, bit cutouts disposed in adjacent fashion in the transverse axis of the key, wherein the engagement positions of the bit cutouts located at the edge are offset from each other in the longitudinal axis of the key relative to the bit cutouts located closer to the central longitudinal plane. Matching the above-described cylinder lock, a flat key according to the invention has two or even three bit cutouts on the edge of the key, at least in the range of an engagement position, and this increases the possible variations for the flat key significantly. The precise engagement positions of the bit cutouts are minimally offset in the longitudinal axis of the key, and this increases the locking security of the lock while tending to thwart any copying of the key. The bit cutouts located at the edge preferably are of a smaller width than those located further inward.

Another feature of the flat key according to the invention is that at least three, preferably five, bit cutouts are provided that differ from each other at their normal distance from the central longitudinal plane and may optionally overlap. The bit cutouts can have a guide surface in the form of a circular-arc-shaped section. As provided by another feature, at least one bit cutout is covered laterally by two ribs of residual key material. This feature also tends to thwart any copying of the key.

Another feature of the flat key according to the invention is that multiple, preferably five, bit cutouts are disposed in the form of a cam on one edge of the edge of the key. This type of cam can also be of an individualized shape and thus have customer-specific profile.

As provided by another feature of the invention, the cam of the bit cutouts located on the edge side has an end chamfer on the key tip that has a greater angle relative to the longitudinal axis than the end chamfer of the guide surfaces located closer to the central longitudinal plane, where its key-tip-side end is located close to the longitudinal axis of the key.

In addition, the flat side faces of the key can have longitudinal shaped grooves. At least two of the longitudinal shaped grooves can be disposed in overlapping fashion on the opposing flat side faces of the key.

In another feature of the invention, curved guide surfaces are provided on the key tip that are configured so as to interact with a guide chamfer at the outer slot end of the cylinder lock, thereby improving the correct centering of the flat key when inserted.

Additional features are found in the attached drawings, claims, and description, in which

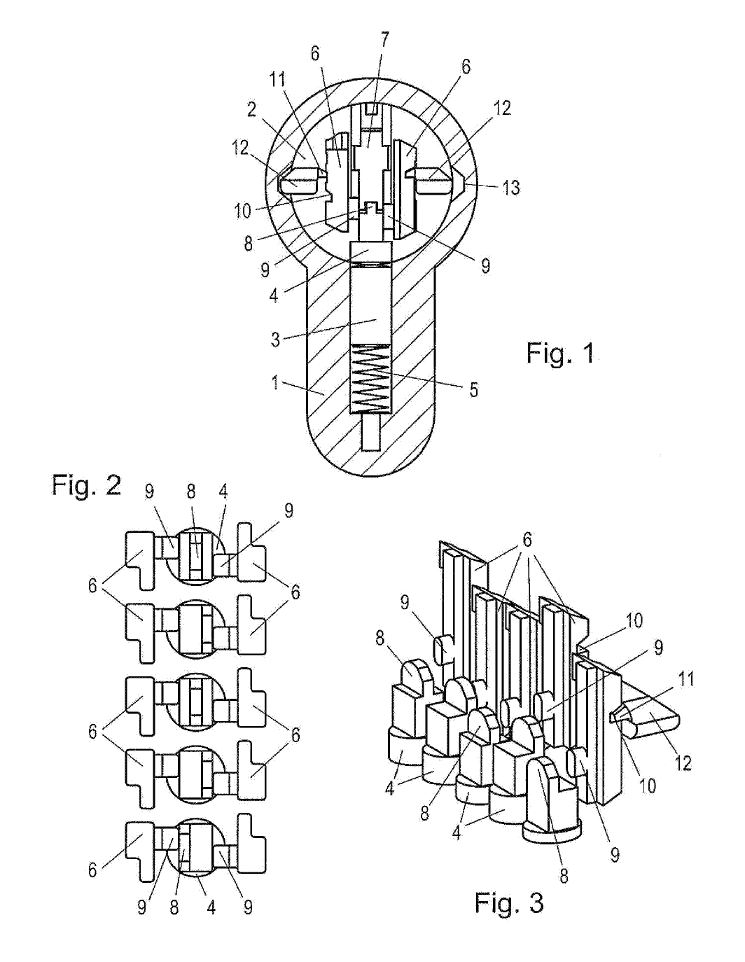

FIG. 1 is a cross-section through a cylinder lock according to the invention.

FIG. 2 is a top view showing the plug pins and plug pins of a cylinder lock according to the invention, the surrounding lock being omitted.

FIG. 3 is a perspective view of five plug pins, as well as five plug pins and a locking element.

FIG. 4 is a front view of a cylinder plug pin, as well as two plug pins, the surrounding lock being omitted.

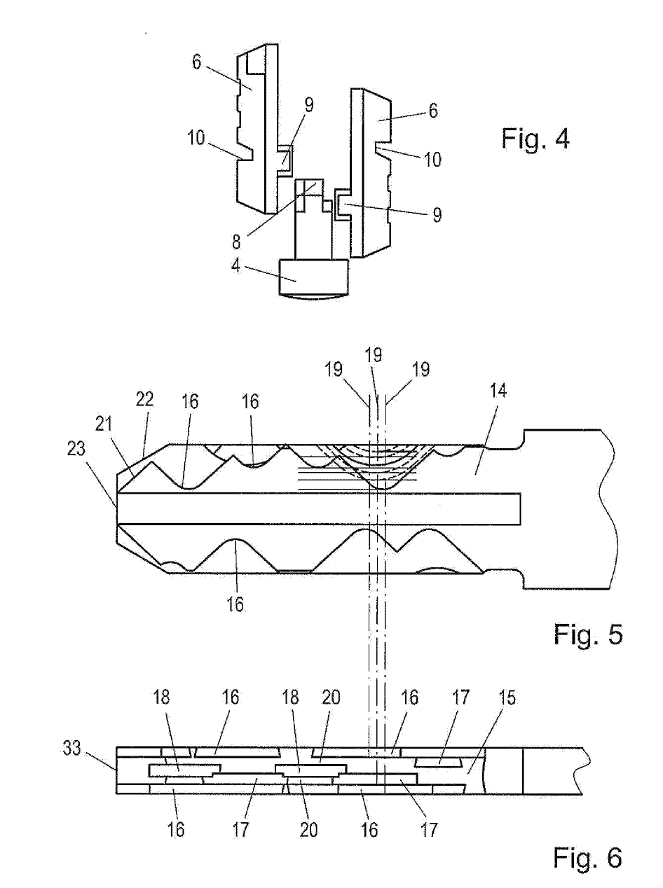

FIG. 5 is a detail side view of a flat key according to the invention.

FIG. 6 is a detail top view of the flat key of FIG. 5.

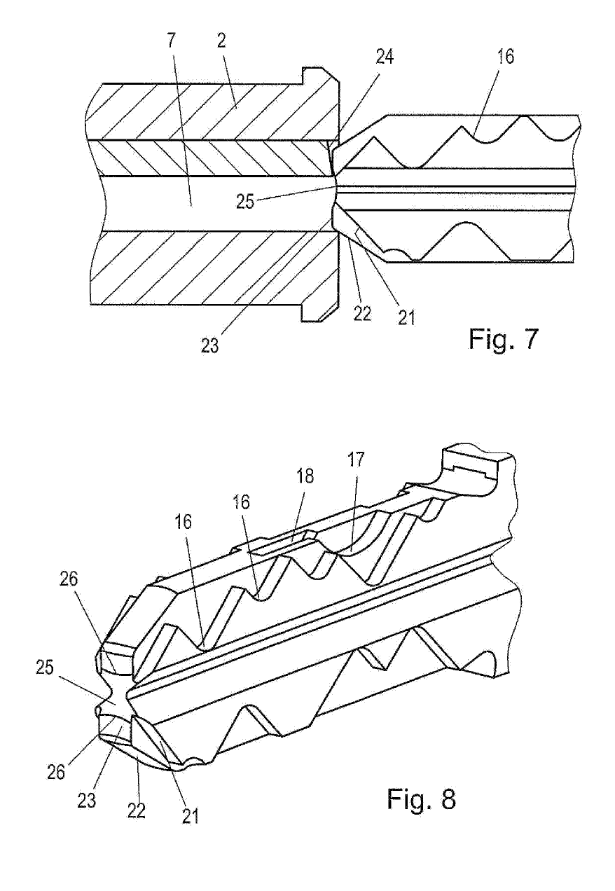

FIG. 7 is a schematic longitudinal section through a cylinder plug and a flat key positioned at the outer slot end.

FIG. 8 is a perspective detail view of a flat key according to the invention.

The cylinder lock shown in FIG. 1 has a casing 1 and a cylinder plug 2 rotatable therein. A flat key in a key slot 7 is engaged by two-part tumblers formed by casing pins 3 and edge plug pins 4 biased by springs 5 toward the cylinder plug 2. At their inner ends, the edge plug pins 4 have extensions 8 that are narrower than the edge of the key and that are aligned in a row extending longitudinally of the key slot 7.

As additional entrainment elements, side plug pins 6 provided on both side faces of the key slot 7 are biased inward by springs. These side plug pins 6 have catch lugs 9 projecting inward into the key slot 7 ane engageable in bit cutouts at the edge of the key.

Release grooves 10 are formed on the faces of the side plug pins 6 that are directed outward away from the key slot, and entrainment studs 11 of locking elements 12 are able to engage these grooves when the correct key is used. When the wrong key is inserted, the entrainment studs 11 cannot engage in the respective release grooves 10 of the side plug pins 6 and thus remain in a detent recess 13 of the casing 1, as the result of which the lock cannot be turned.

The locking situation with the incorrect key inserted is shown in the left half of FIG. 1. The locking situation with the correct key inserted is shown in the right half of FIG. 1.

FIG. 2 is a top view showing five edge plug pins 4, as well as two sets of five side plug pins 6 as used in a cylinder lock according to the invention. To enhance clarity, the surrounding cylinder lock has not been illustrated.

As can be seen in FIG. 2, engagement extensions 8 of the edge plug pins 4 can be set at varying spacings from a central longitudinal plane of the key. Two engagement extensions 8 are at the center, while three engagement extensions are to the left and right of the central longitudinal plane in the example shown. For purposes of further increasing possible variations, the side plug pins 6 engage bit cutouts adjacent the edge of the key. In the illustrated example, bit cutouts of three different depths can thus be engaged simultaneously along the edge of the key so that in the example shown here fifteen bit positions are possible along one edge of the key when all depths are used.

FIG. 3 is a perspective view of the edge plug pins 4 shown in FIG. 2 and of a row of the side plug pins 6 together with their catch lugs 9 projecting into the key slot 7. Also shown is one of the locking elements 12 that can engage with its entrainment studs 11 in the release grooves 10 of the side plug pins 6.

FIG. 4 is another view of one of the cylinder edge plug pins 4 and two side plug pins 6, where again the surrounding cylinder lock is not illustrated for the sake of clarity. As is evident in this view, the catch lugs 9 are oriented such that they can move unimpeded past the cylinder edge plug pins 4, with the result that all the engagement positions possible are able to be engaged without creating any obstruction of the plug pins by the plug pins.

FIGS. 5 and 6 show the edge bitting of a flat key 15 according to the invention having flat key side faces 14 and edges. Side-face edge bit cutouts 16, central bit cutouts 18, as well as bit cutouts 17 at a spacing from the central longitudinal plane are each illustrated. In the illustrated embodiment, this thus produces five possible engagement positions transversely of the edge of the key 15.

Also illustrated are respective engagement positions 19 for the bit cutouts 16, 17. In order to enhance locking security, these engagement positions 19 are offset adjacent one another longitudinally of the key.

In order to enhance security against copying, the step depths, that is, the possible variable depths of the bit cutouts, of the edge-side bit cutouts relative to the center bit cutouts are offset in terms of their depth relative to each other. Three to five different depths can be provided in the bit cutouts located on the central longitudinal plane, a step depth of 0.5 mm being provided in the embodiment illustrated. The edge-side bit cutouts can also be of different depths, where the step depth between two engagement positions measures 0.75 mm. The count indicated for possible depths includes the back edge of the key with a depth of 0 as an engagement position.

In another feature of the flat key according to the invention, at least one bit cutout 18 is laterally closed by two respective ribs 20 of the material forming the key.

Another feature of the key is that an end chamfer 21 for the side plug pins 6 is at a steeper angle relative to the longitudinal axis of the key than an end chamfer 22 for the edge plug pins 4. The end chamfer 21 here also starts closer to the center of a key tip 23 so as to facilitate upward travel of the catch lugs 9 of the side plug pins 6.

FIG. 7 is a schematic longitudinal section through the cylinder plug 2 with the key slot 7. A guide chamfer 24 is formed at the outer slot end, this chamfer interacting with curved guide surfaces 25 and 26, and ensuring simple and correct centering as the key is inserted.

FIG. 8 is a perspective detail view of the key tip 23 of a flat key according to the invention. The circularly arcuate guide surfaces 25 and 26 are provided to improve the centering behavior of the flat key, these guide surfaces ensure that the guide surface 24 slides along the curved surfaces and thus centers the key as the key is inserted.

1. A cylinder lock with a cylinder plug and a casing in which spring-loaded tumbler pins are provided, the lock comprising edge casing pins and edge plug pins for engaging bit cutouts located on the key, the edge plug pins being formed with engagement extensions provided on an inner face and projecting into the key slot, these extensions being narrower than a diameter of the cylinder plug pin and being aligned in a row longitudinally of the key slot, at least two edge plug pins having engagement extensions that are different from one another and positioned either centrally along a central longitudinal plane of the key slot or offset at a spacing roughly parallel thereto on the left and right side faces, these engagement extensions being provided to engage the bit cutouts along the edge of the key, wherein plug pin bores are provided that are parallel to one another on at least one side of the key slot with spring-loaded side plug pins movable therein, the side plug pins having catch lugs projecting into the key slot and terminating short of the central longitudinal plane, the catch lugs being provided to engage the bit cutouts on the edge of the edge of the key, a spacing of the catch lugs from the central longitudinal plane being greater than a spacing of the engagement extensions of the edge plug pins offset to the left or the right of the central longitudinal plane.

2. The cylinder lock according to claim 1, wherein on their faces directed outward away from the key slot the side plug pins have at least one release groove for engagement with entrainment studs of a locking element, and that the locking element is associated with a detent recess of the cylinder casing.

3. The cylinder lock according to claim 1, wherein one row of respective side plug pins with catch lugs is provided on at least one side of the key slot, that at least two, preferably five, side plug pins with respective catch lugs are aligned in a row along the one side of the key slot.

4. The cylinder lock according to claim 1, wherein at least one cylinder edge plug pin and one side plug pin with catch lug, preferably two side plug pins with respective catch lugs, are provided for an engagement position, with the result that at this position the lock is capable of engaging at least two, preferably three bit cutouts along the edge of the key.

5. The cylinder lock according to claim 1, wherein the engagement extensions of the edge plug pins are ridges that normally extend parallel to a central longitudinal plane or on a central longitudinal plane.

6. The cylinder lock according to claim 1, wherein the edge plug pins have side ridges that engage in complementary grooves in the cylinder plug, thereby preventing the edge plug pins from turning.

7. The cylinder lock according to claim 1, wherein the key slot has a guide chamfer at its outer end, the chamfer being at an angle greater than 0° and less than 90° to the vertical, and being oriented so as to interact with curved guide surfaces on the key tip.

8. In combination with the lock of claim 1, s flat key preferably designed with two flat side faces and two edges, the flat key having bit cutouts of varying depth along at least one edge of the key, preferably along both edges of the key, and optionally having additional guide surfaces, notches, or guide grooves on the flat side faces of the key, the bit cutouts being narrower than the edge of the key and lying either centrally on or at a perpendicular spacing parallel to the central longitudinal plane of the key, wherein in a range of an engagement position at least two, preferably three, bit cutouts are disposed adjacent one another transversely of the key, the engagement positions of the bit cutouts located at the edge being offset from each other longitudinally of the key than to the bit cutouts located closer to the central longitudinal plane.

9. The combination according to claim 8, wherein at least three, preferably five, bit cutouts are provided, these bit cutouts differing from each other in their normal offset from the central longitudinal plane, and optionally overlapping each other.

10. The combination according to claim 9, wherein the edge-side bit cutouts are of narrower width than bit cutouts located closer to the central longitudinal plane.

11. The combination according to claim 8 wherein the bit cutouts have guide arcuate part-circular surfaces.

12. The combination according to claim 8 wherein at least one bit cutout is defined between ribs of the material of the key.

13. The combination according to claim 8 wherein multiple, preferably five, bit cutouts are provided on the edge of the edge of the key in the form of a cam.

14. The combination according to claim 12, wherein the cam of the bit cutouts located on the edge side has an end chamfer at the key tip, this chamfer having a greater angle relative to the longitudinal axis than sm he end chamfer of the guide surfaces located closer to the central longitudinal plane, and that its key-tip end is close to the longitudinal axis of the key.

15. The combination according to claim 8 wherein curved guide surfaces are provided at the key tip that are configured so as to interact with a guide chamfer at the outer slot end of the cylinder lock, thereby improving correct centering of the flat key when it is inserted.
